(19) United States
(12) Patent Application Publication
(10) Pub. No.: US 2009/0168013 A1
(43) Pub. Date: Jul. 2, 2009

(54) Trimethylsilyl-Capped Polysiloxane Macromonomers Containing Polar Fluorinated Side-Chains

(76) Inventors: Jay F. Kunzler, Canandaigua, NY (US); Richard M. Ozark, Solvay, NY (US); Joseph A. McGee, Canandaigua, NY (US); Joseph C. Salamone, San Antonio, TX (US)

Correspondence Address: Bausch & Lomb Incorporated, One Bausch & Lomb Place, Rochester, NY, 14604-2701, US

(21) Appl. No.: 12/269,442

(22) Filed: Nov. 12, 2008

Related U.S. Application Data
(60) Provisional application No. 61/016,846, filed on Dec. 27, 2007.

(51) Int. Cl. G02C 7/04; C07F 7/02; C08F 290/06

(52) U.S. Cl. 351/160 R; 523/107; 556/450

(57) ABSTRACT

A method for reducing the modulus of polymer siloxane hydrogel compositions by employing monomeric polysiloxanes endcapped with trimethylsilyl to reduce the crosslinking density of the hydrogel. The synthesis consists of a single vessel acid catalyzed ring opening polymerization and may be employed to produce copolymers useful as hydrogel contact lens materials.

### PRIORITY CLAIMS TO PRIOR APPLICATIONS

This application claims the benefit of Provisional Patent Application No. 61/016,846 filed Dec. 27, 2007 which is incorporated by reference herein.

### FIELD OF THE INVENTION

The present invention generally relates to siloxane-containing hydrogel compositions useful as biomedical devices, such as contact lenses and intraocular lenses.

### BACKGROUND OF THE INVENTION

Polymeric siloxane materials have been used in a variety of biomedical applications, including, for example, in contact lenses and intraocular lenses. Such materials can generally be subdivided into hydrogels and non-hydrogels. Siloxane-containing hydrogels constitute crosslinked polymeric systems that can absorb and retain water in an equilibrium state and generally have a water content greater than about 5 weight percent and more commonly between about 10 to about 80 weight percent. Such materials are usually prepared by polymerizing a mixture containing at least one siloxane-containing monomer and at least one hydrophilic monomer. Either the siloxane-containing monomer or the hydrophilic monomer may function as a crosslinking agent (a crosslinker being defined as a monomer having multiple polymerizable functionalities) or a separate crosslinker may be employed.

Siloxane-containing hydrogens combine the beneficial properties of hydrogels with those of siloxane-containing polymers (Kunzler and McGee, “Contact Lens Materials”, Chemistry & Industry, pp. 651-655, 21 August 1995). Siloxane-containing hydrogels have been used to produce a contact lens that combines the high oxygen permeability of polydimethylsiloxane (PDMS) materials with the comfort, wetting and deposit resistance of conventional non-ionic hydrogels.

Monomers that have been found to be particularly useful for preparing siloxane-containing contact lenses are described in U.S. Pat. Nos. 4,136,250; 4,153,641; 4,189,546; 4,208,506; 4,217,038; 4,277,595; 4,327,203; 4,355,147; 4,740,533; 4,780,515; 5,034,461; 5,070,215; 5,310,779; 5,346,976; 5,374,662; 5,358,995; 5,387,632; 5,420,324; and 5,496,871.

U.S. Pat. No. 4,153,641 (Deichert et al.) discloses contact lenses made from poly(organosiloxane) monomers which are α,ω-terminally bonded through a divalent hydrocarbon group to a polymerized activated unsaturated group. Various hydrophobic siloxane-containing prepolymers such as 1,3-bis(methacryloyloxyalkyl) polysiloxanes were copolymerized with known hydrophilic monomers such as 2-hydroxyethyl methacrylate (HEMA). These materials were used to produce lenses which had a low water content and a high modulus (greater than 300 g/mm²).

U.S. Pat. No. 5,321,108 (Kunzler et al.) discloses α,ω-polymerizable siloxane monomers having fluorinated side groups.

U.S. Pat. No. 5,358,995 (Lai et al.) describes a siloxane hydrogel which is comprised of an acrylic ester-capped polysiloxane prepolymer, polymerized with a bulky polysiloxanyalkyl (meth)acrylate monomer, and at least one hydrophilic monomer. The acrylic ester-capped polysiloxane prepolymer, commonly known as M₂Dₓ consists of two acrylic ester end groups and “x” number of repeating dimethylsiloxane units. The preferred bulky polysiloxanyakyl (meth)acrylate monomers are TRIS-type (3-methacryloyloxypropyltris(trimethylsiloxy)silane) with the hydrophilic monomers being either acrylic- or vinyl-containing. While the properties of these lenses are acceptable, the modulus of these lenses can be high, which may result in damage to the epithelial layer and poor comfort.

U.S. Pat. No. 6,056,976 (Markkula et al.) discloses a trifluoropropyl substituted siloxane.

Designing siloxane based hydrogels utilizing M₂Dₓ as the base prepolymer has mainly involved copolymerizing the prepolymer with hydrophilic monomers, such as N,N-dimethylacrylamide and N-vinylpyrrolidone. Polysiloxane is hydrophobic and has poor compatibility with hydrophilic monomers, especially when the M₂Dₓ prepolymer is of high molecular weight. Poor compatibility results in phase separated, opaque materials. This can be particularly problematic when preparing hydrogels to be used as optically clear contact lenses.

Reducing the molecular weight of the M₂Dₓ prepolymer can improve the incompatibility. Unfortunately, low molecular weight M₂Dₓ prepolymers typically result in hydrogels of high modulus. This is a direct result of the higher crosslink density of these low molecular weight M₂Dₓ based hydrogels.

In designing a low modulus siloxane hydrogel based on low molecular weight M₂Dₓ prepolymers, one approach can be to use high concentrations of hydrophilic monomers. The lower modulus for these materials is a result of the higher water content and lower crosslink density. The major drawback of this approach is that the higher water content materials possess lower levels of oxygen permeability, due to the lower concentration of siloxane in these materials. The low levels of oxygen permeability are not suitable for continuous wear contact lens application.

Another approach in the development of low modulus siloxane hydrogels based on low molecular weight M₂Dₓ prepolymers is through the incorporation of the monomer 3-methacryloyloxypropyltris(trimethylsiloxy)silane (“TRIS”). Higher concentrations of TRIS results in hydrogels of lower modulus, but lenses made with high TRIS levels overall tend not to perform well in clinical studies.

The development of low modulus hydrogels based on low molecular weight M₂Dₓ prepolymers may be accomplished through the addition of siloxane macromonomers, such as those taught by Y. Kawakami in Polymer Journal, v. 14, p. 913, 1982. High levels of siloxane macromonomer may reduce the modulus by lowering the crosslink density of the resultant hydrogel without a significant reduction in oxygen permeability. The major disadvantage of this route is that the methacrylate based siloxane macromonomers are very difficult to synthesize. The synthesis of siloxane macromonomers requires several steps.

### SUMMARY OF THE INVENTION

There remains a need for a contact lens material having the high oxygen permeablity of a polysiloxane-containing prepolymer, yet having a modulus low enough to be used as a contact lens. The approach taken in this invention alters the siloxane-containing monomer to affect the polymer properties. By lowering the methacrylate functionality of M₂Dₓ, the crosslinking density is reduced. This can be done by substituting the polymerizable methacrylate group on one end of the prepolymer with a silane group such that MDₓ is obtained.

These improved polymeric siloxane hydrogel compositions are formed from the polymerization product of a monomer mixture comprising a siloxane prepolymer having the general formula (I):

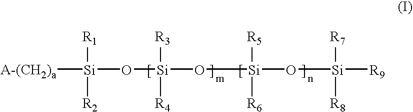

wherein;
A is an activated unsaturated radical;
R₁, R₂ and R₇-R₉ are independently an alkyl, cycloalkyl or aryl, arylalkyl, or siloxanyl, R₃-R₆ are independently alkyl, aryl, alkylaryl, or fluoroalkyl with the proviso that at least one of R₃-R6 is a fluoroalkyl;
m and n are independently 0 to 200, m+n being from about 3 to 200; and a is 1 to 10.

In particular, this invention is directed to preparing a prepolymer that is endcapped with trimethylsilyl (TMS) as shown in formula II or trimethylsiloxanyl (TMSO) as shown in formula III:

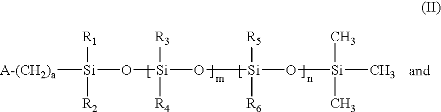

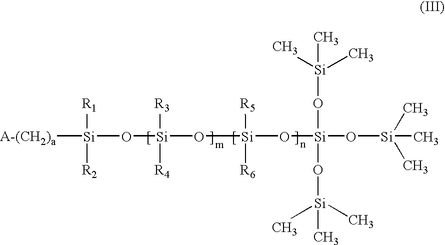

wherein A, R₁-R₆, and a are as defined above and m+n is 15 to 200.

The hydrogel material is especially useful in biomedical devices such as soft contact lenses, intraocular lenses, heart valves and other prostheses.

### DETAILED DESCRIPTION OF PREFERRED EMBODIMENTS

The fluorinated polysiloxane-containing monomers disclosed herein surprisingly display outstanding compatibility by being highly soluble in various hydrophilic compounds, such as N-vinylpyrrolidone (NVP) and N,N-dimethylacrylamide (DMA), without the need for additional compatibilizers or solubilizers.

As used herein, the term “side group” refers to any chain branching from a siloxane group, and may be a side chain when the siloxane is in the backbone of the polymeric structure. When the siloxane group is not in the backbone, the fluorinated strand or chain which branches out from the siloxane group becomes a side chain off of the siloxane side chain.

The “terminal” carbon atom refers to the carbon atom located at a position furthest from the siloxane group to which the fluorinated strand, or side group is attached.

It was discovered and is disclosed herein that when the polar fluorinated group, —D—(CF₂)_{z}—H or —D—(CF₂)_{z}C(CF₃)₂—H, wherein z is 1 to 20; and D is a bond or an alkyl or alkylene radical having 1 to 10 carbon atoms and which may have ether linkages between carbon atoms, is placed at the end of a side group attached to a siloxane-containing monomer, the entire siloxane monomer to which the side group is attached is rendered highly soluble in hydrophilic monomers, such as NVP. When the hydrogen atom in the terminal fluorinated carbon atom is replaced with a fluoro group, the siloxane-containing monomer is significantly less soluble, or not soluble at all in the hydrophilic monomer present. This solubility is thought to be due to the hydrogen-bonding ability of the —(CF₂)_{z}—H or the —C(CF₃)₂—H group with another hydrogen-bonding group, such as in NVP. Without this hydrogen bonding group contributing to solubilization of the MDₓ monomer, solubilization in polar monomers could be more difficult.

In one embodiment of the present invention, disclosed are the fluorinated siloxane-containing monomers having the following general schematic representation (I):

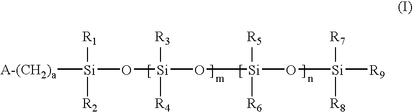

wherein;
A is an activated unsaturated radical;
R₁, R₂ R₇-R₉ are independently an alkyl, cycloalkyl or aryl, arylalkyl, or siloxanyl,
R₃-R₆ are independently alkyl, aryl, alkylaryl, or fluoroalkyl with the proviso that at least one of R₃-R₆ is a fluoroalkyl;
m and n are independently 0 to 200, m+n being from about 3 to 200; and a is 1 to 10.

In another embodiment of the invention provided are prepolymers that are endcapped with trimethylsilyl (TMS) as shown in formula II:

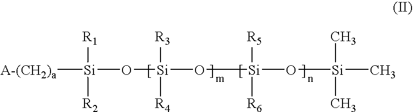

wherein A, R₁-R₆, and a are as defined above and m+n is 15 to 200.

In one embodiment of the present invention, fluorinated siloxane-containing monomers are disclosed having at least one fluorinated side group, said side group having the general schematic representation (III) and (IV):

—D—(CF₂)₂H (III)

—D—(CF₂)_{z}C(CF₃)₂—H (IV)

wherein z is 1 to 20; and D is a bond or an alkyl or alkylene radical having 1 to 10 carbon atoms and which may have ether linkages between carbon atoms.

In a further embodiment, the fluorinated siloxane-containing monomers have at least one fluorinated side group and have a moiety of the following general schematic representation (V) and (VI):

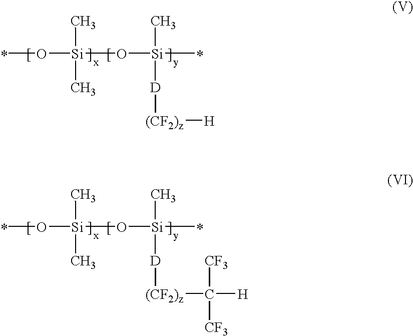

wherein: D is an alkyl or alkylene group having 1 to 10 carbon atoms and which may have ether linkages between carbon atoms; x is ≧0; y is ≧1; x+y=2 to 1000; and z is 1 to 20.

Preferably, the fluorinated side group is represented by the formula (VII) or (VIII):

—CH₂—CH₂—CH₂—O—CH₂—(CF₂)_{z}—H (VII)

—CF₂C(CF₃)₂—H (VIII)

wherein z is 1 to 20.

One preferred fluorinated siloxane-containing monomer, is prepared according to the following reaction scheme:

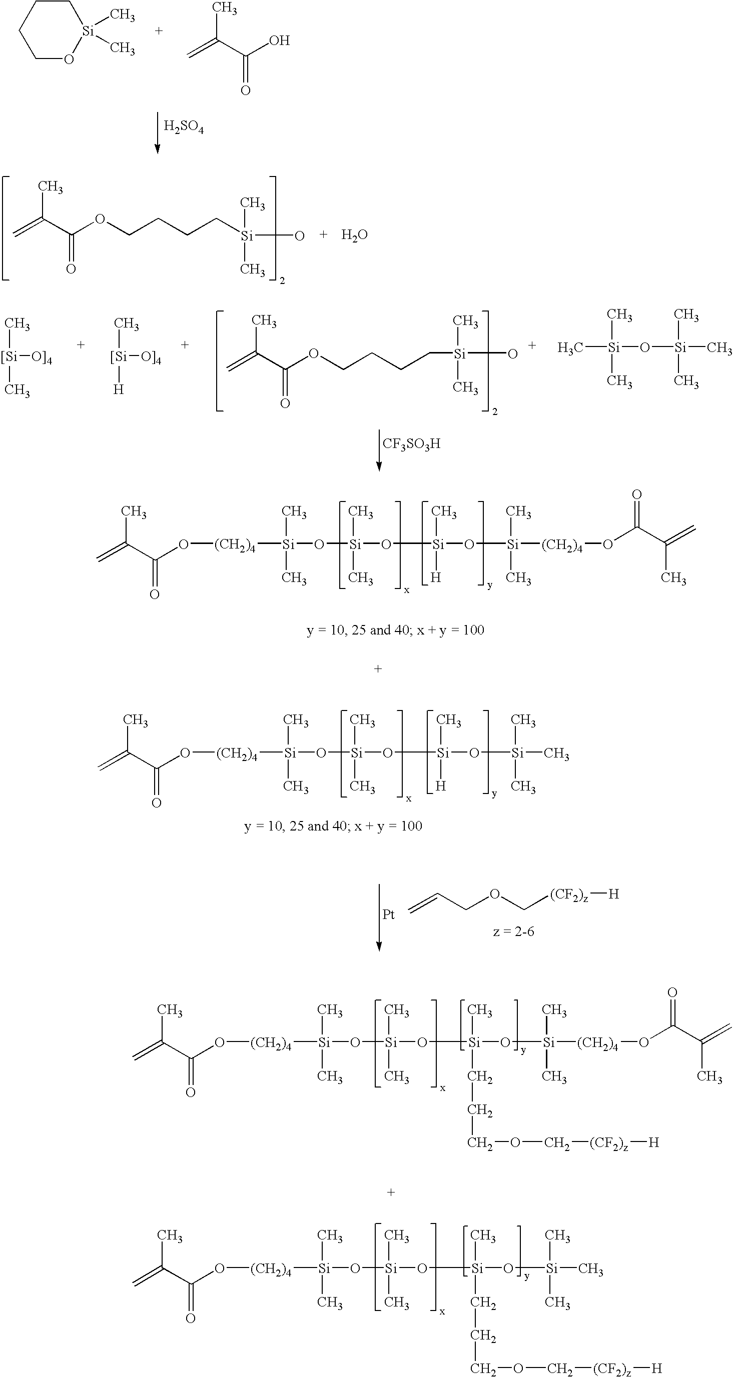

The fluorinated polysiloxane-containing monomers of the present invention combine the desirable features of known hydrophilic side chain polysiloxanes, such as relative compatibility with hydrophilic monomers, with improved deposit resistance provided by the fluorinated group. Desired properties of the lenses may be affected and controlled, for example, by altering the relative ratio of the comonomers (the aforementioned fluorinated polysiloxane monomer to the hydrophilic monomer or monomers). The relative softness or hardness of the contact lenses fabricated from the resulting polymers of this invention can be varied by decreasing or increasing the molecular weight of the polysiloxane monomer α-end-capped with the activated unsaturated group or by varying the percent of the comonomers present.

The present invention contemplates the use of the fluorinated polysiloxane monomer for both “hard” and “soft” contact lenses, the disclosed formulations are thought to be especially useful as “soft” hydrogel contact lenses. A lens is considered to be “soft” if it can be folded back upon itself without breaking.

A hydrogel is a hydrated crosslinked polymeric system that contains water in an equilibrium state. Siloxane-containing hydrogels (i.e., hydrogels containing siloxane groups) are usually prepared by polymerizing a mixture containing at least one siloxane-containing monomer and at least one hydrophilic monomer. Either the siloxane-containing monomer or the hydrophilic monomer may function as a crosslinking agent (a crosslinker), being defined as a monomer having multiple polymerizable functionalities. Alternatively, an additional crosslinker may be employed.

When the term “activated” is used with the term “unsaturated group” herein, it is meant that an unsaturated group which is activated is one which has a substituent which facilitates free radical polymerization. These activated unsaturated groups are polymerized to form the polymers of the present invention. Preferred activated unsaturated groups include acryloyloxy, methacryloyloxy, acrylamido, methacrylamido, styryl, vinylbenzyl, vinyl, vinyloxy, maleimido, furmaroyl, vinyl urethane, and vinyl carbamate, vinyl sulfone, and the like. Preferably the activating groups lend themselves to polymerization under facile conditions, such as from ambient temperatures to less than 100° C.

When the term “polymerization” is used herein we refer to the polymerization of the double bonds of the polysiloxanes endcapped with polymerizable unsaturated groups which results in a crosslinked three dimensional network.

Further, notations such as “(meth)acrylate” or “(meth)acrylamide” are used herein to denote optional methyl substitution. Thus, for example, (meth)acrylate includes both acrylate and methacrylate and N-alkyl(meth)acrylamide includes both N-alkylacrylamide and N-alkylmethacrylamide.

The term “prepolymer” denotes a monomer which may be a high molecular weight monomer containing at least two polymerizable groups. The monomers added to the monomeric mixture of the present invention may be monomers or prepolymers. Thus, it is understood that the terms “siloxane-containing monomers” and “hydrophilic monomers” include corresponding prepolymers. Examples of such monomers can be found in U.S. Pat. Nos. 4,136,250; 4,153,641; 4,740,533; 5,034,461 and 5,070,215.

The terms “shaped articles for use in biomedical applications” or “biomedical devices or materials” mean the hydrogel materials disclosed herein have physicochemical properties rendering them suitable for prolonged contact with living tissue, blood and the mucous membranes.

The monomers of the present invention can be used to produce highly wettable hydrogels with ideal rigidity, oxygen permeability and other physical properties. Such siloxane-containing hydrogels are well-suited for use as biomedical devices such as contact lenses.

Certain crosslinked polymeric materials, such as those contemplated by the present invention, may be polymerized to form a hard water-free xerogel. Xerogels are understood to be unhydrated hydrogel formulations which may be physically altered to, for example, impart optical properties through machining, and then be hydrated and retain their water content and optical properties.

Preferred acrylic-capped polysiloxane monomers of the present invention are those having from about 1 to about 200 repeating siloxy units, and most preferably have about 100 repeating siloxy units.

The fluorinated bulky polysiloxanylalkyl (meth)acrylate-containing monomers of the present invention are excellent materials for use with both “hard” and “soft” systems which may or may not be hydrogels.

The preferred fluorinated side groups are the alkyl fluorinated side chains, such as the propyloxyoctafluoropentanes, the propyloxytetrafluoropropanes and the propyloxydodecafluoroheptanes, with the propyloxyoctafluoropentanes being the most preferred.

The present invention contemplates, in one preferred embodiment, polymerizing, in a monomer mix a polysiloxane monomer which has at least one polar fluorinated siloxane-containing monomer with at least two hydrophilic monomers to produce a contact lens material.

Additional hydrophilic monomers may be incorporated into the polymeric compositions contemplated by the present invention to form hydrogels. Such preferred hydrophilic monomers may be either acrylic- or vinyl-containing and may be used as crosslinking agents. The term “vinyl-type” or “vinyl-containing” monomers refers to non-acrylic monomers containing the vinyl grouping (CH₂═CH—). Such hydrophilic vinyl-containing monomers are known to polymerize relatively easily. “Acrylic-type” or “acrylic-containing” monomers are those monomers containing the acrylic group (CH═CR(C═O)X) wherein R is H or CH₃, and X is O or NH.

Preferred hydrophilic vinyl-containing monomers which may be incorporated into the hydrogels of the present invention include monomers such as N-vinyl lactams (e.g. N-vinylpyrrolidone (NVP)), N-vinyl-N-methylacetamide, N-vinyl-N-ethylacetamide, N-vinyl-N-ethylformamide, N-vinylfoimamide, with NVP being the most preferred.

Preferred hydrophilic acrylic-containing monomers which may be incorporated into the hydrogel of the present invention include hydrophilic monomers such as N,N-dimethylacrylamide (DMA), 2-hydroxyethyl methacrylate, glycerol methacrylate, 2-hydroxyethyl methacrylamide, methacrylic acid and acrylic acid, with DMA being the most preferred.

The preferred siloxane-containing vinyl carbonate or vinyl carbamate monomers include: 1,3-bis[4-vinyloxycarbonyloxy)but-1-yl]tetramethyldisloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propylallyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate; and “V₂D₂₅” as shown in the following formula:

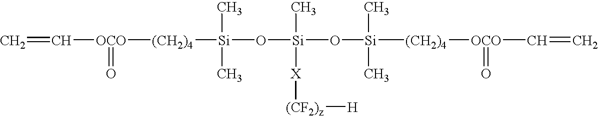

wherein X is an alkyl or alkylene group having 1 to 10 carbon atoms and which may have ether linkages between carbon atoms; and z is 1 to 20.

When it is desirable for both an acrylic-containing hydrophilic monomer and a vinyl-containing hydrophilic monomer to be incorporated into the siloxane-containing polymer of the present invention, a further crosslinking agent having both a vinyl and an acrylic polymerizable group may be used since these vinyl and acrylic hydrophilic monomers have different reactivity ratios and copolymerize at vastly different rates or will not copolymerize at all. Such crosslinkers, such as methacryloxyethyl vinyl carbonate (HEMAVc) and methacryloylethyl vinyl carbamate, which facilitate the copolymerization of the comonomers and are the subject of presently co-pending and commonly assigned U.S. Pat. No. 5,310,779, granted May 10, 1994.

Such crosslinkers help to render the resulting copolymer totally UV-curable. However, the copolymer could also be cured solely by heating, or with a combined UV and heat regimen. Therefore, it is understood that the necessary photo and thermal initiators required to cure the copolymer may be comprised therein as would be apparent to those skilled in the art.

Other crosslinking agents which may be incorporated into the siloxane-containing hydrogel of the present invention include polyvinyl, typically di- or tri-vinyl monomers, most commonly the di- or tri(meth)acrylates of dihydric ethylene glycol, triethylene glycol, butylene glycol, hexane-1,6-diol, thio-diethylene glycol-diacrylate and methacrylate; neopentyl glycol diacrylate; trimethylolpropane triacrylate and the like; N,N′-dihydroxyethylene-bisacrylamide and-bismethacrylamides; also diallyl compounds like diallyl phthalate and triallyl cyanurate; divinylbenzene; ethylene glycol divinyl ether; and the (meth)acrylate esters of polyols such as triethanolamine, glycerol, pentanerythritol, butylene glycol, mannitol, and sorbitol. Further, illustrations include N,N-methylene-bis-(meth)acrylamide, sulfonated divinylbenzene, and divinylsulfone. Also useful are the reaction products of hydroxyalkyl (meth)acrylates with unsaturated isocyanates, for example the reaction product of 2-hydroxyethyl methacrylate with 2-isocyanatoethyl methacrylate (IEM) as disclosed in U.S. Pat. No. 4,954,587.

Other known crosslinking agents are polyether-bisurethane-dimethacrylates as described in U.S. Pat. No. 4,192,827, and those crosslinkers obtained by reaction of polyethylene glycol, polypropylene glycol and polytetramethylene glycol with 2-isocyanatoethyl methacrylate (IEM) or m-isopropenyl-γ,γ,-dimethylbenzyl isocyanates (m-TMI), and polysiloxane-bisurethane-dimethacrylates as described in U.S. Pat. Nos. 4,486,577 and 4,605,712. Still other known crosslinking agents are the reaction products of poly(vinyl alcohol), ethoxylated poly(vinyl alcohol) or of poly(vinyl alcohol-co-ethylene) with 0.1 to 10 mol % vinyl isocyanates like IEM or m-TMI.

Bulky monomers may also be copolymerized with the monomers of the invention herein. Preferred bulky monomers specifically include 3-methacryloxypropyltris(trimethylsiloxy)silane (“TRIS”), pentamethyldisiloxanylmethyl methacrylate, phenyltetramethyldisiloxanylethyl acrylate, methyldi(trimethylsiloxy)methacryloxymethyl silane, 3-[tris(trimethylsiloxy)silyl]propyl vinyl carbamate, 3-[tris(trimethylsiloxy)silyl]propyl allyl carbamate, and 3-[tris(trimethylsiloxy)silyl]propyl vinyl carbonate.

The monomer mixture of the present invention may include additional constituents such as UV-absorbing agents, internal wetting agents, hydrophilic monomeric units, toughening agents, or colorants such as those known in the contact lens art.

Conventional curing methods in polymerizing ethylenically unsaturated compounds such as UV polymerization, thermal polymerization, or combinations thereof, can be used to cast these monomer mixtures. Representative free radical thermal polymerization initiators can be organic peroxides and are usually present in the concentration of about 0.01 to 1 percent by weight of the total monomer mixture. Representative UV initiators are known in the field such as, benzoin methyl ether, benzoin ethyl ether, 1164, 2273, 1116, 2959, 3331 (EM Industries) and Irgacure 651 and 184 (Ciba-Geigy). In the preferred embodiment, Darocur 1173 is the UV initiator.

Polymerization of the prepolymer of this invention with other copolymers is generally performed in the presence of a diluent. The diluent is generally removed after polymerization and replaced with water in extraction and hydration protocols well known to those skilled in the art. Representative diluents are diols, alcohols, alcohol/water mixtures, ethylene glycol, glycerine, liquid poly(ethylene glycol), low molecular weight linear poly(hydroxyethyl methacrylate)s, glycol esters of lactic acid, formamides, ketones, dialkylsulfoxides, butyl carbitol, and the like. Preferred diluents include hexanol and nonanol.

It is also possible to perform the polymerization in the absence of diluent to produce a xerogel. These xerogels may then be hydrated to form hydrogels as is well known in the art.

The monomer mixture may include a tinting agent, defined as an agent that, when incorporated in the final lens, imparts some degree of color to the lens. Conventional tinting agents are known in the art, including non-polymerizable agents, or polymerizable agents that include an activated unsaturated group that is reactive with the lens-forming monomers. One preferred example of this latter class is the compound 1,4-bis[4-(2-methacryloxyethyl)phenylamino)]anthraquinone, a blue visibility-tinting agent disclosed in U.S. Pat. No. 4,997,897 (Melpolder).

The monomer mixture may also include a UV-absorbing agent, defined as an agent that reduces light in the general region of 200 to 400 nm. Representative polymerizable UV absorbing materials for contact lens applications are described in U.S. Pat. Nos. 4,304,895 (Loshaek), 4,528,311 (Beard et al.), 4,716,234 (Dunks et al.), 4,719,248 (Bambury et al.), 3,159,646 (Milionis et al.) and 3,761,272 (Manneus et al.). Examples of UV-absorbing compounds include the benzotriazoles and benzophenones.

The resulting polymers of this invention can be formed into contact lenses by the spincasting processes such as those disclosed in U.S. Pat. Nos. 3,408,429 and 3,496,254 and other conventional methods, such as compression molding as disclosed in U.S. Pat. Nos. 4,084,459 and 4,197,266.

Polymerization may be conducted either in a spinning mold, or a stationary mold corresponding to a desired contact lens shape. The thus-obtained contact lens may be further subjected to a mechanical finishing, as occasion demands. Also, the polymerization may be conducted in an appropriate mold or vessel to give a lens material in the form of button, plate or rod, which may then be processed (e.g., cut or polished via lathe or laser) to give a contact lens having a desired shape.

The hydrogels produced by the present invention are oxygen transporting, hydrolytically stable, biologically inert, and transparent. The monomers and copolymers employed in accordance with this invention, are readily polymerized to form three dimensional networks which permit the transport of oxygen and are optically clear, strong and hydrophilic.

The present invention provides materials which can be usefully employed for the fabrication of prostheses such as heart valves and intraocular lenses, as optical contact lenses or as films. More particularly, the present invention concerns contact lenses.

The present invention further provides articles of manufacture which can be used for biomedical devices, such as, surgical devices, heart valves, vessel substitutes, intrauterine devices, membranes and other films, diaphragms, surgical implants, blood vessels, artificial ureters, artificial breast tissue and membranes intended to come into contact with body fluid outside of the body, e.g., membranes for kidney dialysis and heart/lung machines and the like, catheters, mouth guards, denture liners, intraocular devices, and especially contact lenses.

It is known that blood, for example, is readily and rapidly damaged when it comes into contact with artificial surfaces. The design of a synthetic surface which is antithrombogenic and nonhemolytic to blood is necessary for prostheses and devices used with blood.

The following examples serve only to further illustrate aspects of the present invention and should not be construed as limiting the invention. This invention describes a novel approach to the design of low modulus siloxane hydrogels based on MDₓ prepolymers. The MDₓ prepolymers of this invention contain a “built-in” modulus reducing functionality: a trimethylsilyl (TMS) endcap. Increasing the concentration of the TMS endcap (or reducing the concentration of the methacrylate cap) results in lower modulus, transparent siloxane hydrogels without a reduction in water transport or oxygen permeability.

### EXAMPLES

### Experimental

### Materials

The ultraviolet initiator Darocur 1173 (2-hydroxy-2-methyl-1-phenyl-propan-1-one) is purchased from EM Science and is used as received. Dimethylacrylamide (DMA), 2-N-vinyl pyrrolidinone (NVP), tetrafluoro-1-pentanol (TFP), octafluoro-1-pentanol (OFP), dodecafluoro-1-nonanol (DDN), and allyl bromide (AB) were purchased from Aldrich Chemical Co. The TFP, OFP and DDN were used as received. The DMA, NVP and AB were distilled under nitrogen prior to use. Octamethylcyclotetrasiloxane (D₄), tetramethylcyclotetrasiloxane (D₄H), hexamethyldisiloxane (HMDS) and 1,3-tetramethyl disiloxane platinum complex (2% platinum in xylenes) were purchased from Hüls. The D₄H is distilled prior to use under dry nitrogen. The fluorinated allylic ethers, allyloxy tetrafluoropentane, allyloxy octafluoropentane and allyloxy dodecafluorotridecane were prepared by the phase transfer catalyzed reaction of allyl bromide with the corresponding fluorinated alcohol using tetrabutylammonium hydrogen sulfate, tetrahydrofuran and 50% (w/w) NaOH. All other solvents and reagents were used as received.

Synthesis of 1,3-bis (4-methacryloyloxybutyl) tetramethyl disiloxane (M₂)(Scheme 1)

To a 5 liter four neck resin flask equipped with a mechanical stirrer, Dean-Stark trap, heating mantle, water cooled condenser and thermometer is added 1,1-dimethyl-1-sila-2-oxacyclohexane (521 g, 4.0 mole), methacrylic acid (361 g, 4.2 mole), and concentrated sulfuric acid (25.5 g, mole). To the reaction mixture is then added 1 L of cyclohexane and hydroquinone (0.95 g, 8.6 mmole) as a polymerization inhibitor. The reaction mixture is heated to reflux for five hours during which time 28 mL of water is collected. The reaction mixture is then cooled, divided, and passed through two chromatography columns filled with 1 kg of alumina (packed using cyclohexane as eluant). The cyclohexane is removed using a rotary evaporator and the resultant M₂ is placed under vacuum (0.2 mm Hg) for one hour at 80° C.

Synthesis of methacrylate end-capped poly (25 mole % methyl siloxane)-co-(75 mole % dimethylsiloxane)(M₂D₇₅D₂₅H)(Scheme 2)

To a 1000 mL round bottom flask under dry nitrogen is added D₄ (371.9 g, 1.25 mole), D₄H (100.4 g, 0.42 mole), M₂ (27.7 g, 0.7 mole) and HMDS (varies depending on desired substitution of terminal trimethylsilyl groups). Trifluoromethane sulfonic acid (0.25%, 1.25 g, 8.3 mmole) is added as initiator. The reaction mixture is stirred 24 hours with vigorous stirring at room temperature. Sodium bicarbonate (10 g, 0.119 mole) is then added and the reaction mixture is again stirred for 24 hours. The resultant solution is filtered through a 0.3μ teflon® filter. The filtered solution is vacuum stripped and placed under vacuum (>0.1 mm Hg) at 50° C. to remove the unreacted silicone cyclics.

General procedure for the synthesis of the fluoro side chain siloxanes: synthesis of methacrylate (with varying levels of trimethylsilyl capped terminal groups) end-capped poly (25 mole % (3-(2,2,3,3,4,4,5,5-octafluoropentoxy)propyl methyl siloxane)-co-(75 mole % dimethylsiloxane)(scheme 2)

To a 500 mL round bottom flask equipped with a magnetic stirrer and water condenser is added M₂D₇₅D₂₅H (15 g, 0.002 mole), allyloxyoctafluoropentane (27.2 g, 0.1 mole), tetramethyldisiloxane platinum complex (2.5 mL of a 10% solution in xylenes), 75 mL of dioxane and 150 mL of anhydrous tetrahydrofuran under a nitrogen blanket. The reaction mixture is heated to 75° C. and the reaction is monitored by IR and ¹H—NMR spectroscopy for loss of silicone hydride. The reaction is complete in 4 to 5 hours of reflux. The resulting solution is placed on a rotoevaporator to remove tetrahydrofuran and dioxane. The resultant crude product is diluted with 300 mL of a 20% methylene chloride in pentane solution and passed through a 15 gram column of silica gel using a 50% solution of methylene chloride in pentane as eluant. The collected solution is again placed on the rotoevaporator to remove solvent and the resultant clear oil is placed under vacuum (>0.1 mm Hg) at 50° C. for four hours.

### Techniques

Monomer purity is determined on a Hewlett-Packard HP5890A GC using a 15 m X 0.53 mm I.D. X 1.2 μm column of Alltech EC-5 (SE-4). The monomer and prepolymer structure is confirmed by 200 MHz ¹H—NMR spectroscopy using a Varian 200 spectrometer. Films were cast between silanized glass plates with a 0.3 mm Teflon spacer. The optimum cure conditions consisted of 1 h UV at room temperature using a UV intensity of 3500 μW/cm² and 0.5% Darocur 1173 as the initiator. The resultant films were extracted 16 hours in 2-propanol and two hours in distilled water followed by a 16 hour hydration in phosphate-buffered saline (pH 7.3). The water content is determined using the following equation:

% H₂O=(hydrated weight−dry weight/hydrated weight) X100

The mechanical properties of films were determined on an Instron Model 4500 using ASTM methods 1708 and 1938. The relative molecular weights of soluble polymers were determined by size exclusion chromatography (SEC) with a Waters 820 LC using polystyrene standards (THF/2 ml/min.). Oxygen permeability (Dk) is determined using the polarographic probe method.¹² The hydrolytic stability test consisted of heating the test films in phosphate-buffered saline for 14 days at 80° C. and monitoring the weight loss and change in water content (two year shelf-life equivalency).

We claim:

1. Fluorinated siloxane-containing monomers having the following general schematic representation (I): 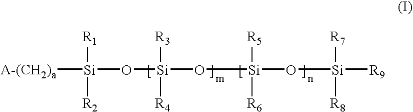
wherein;
A is an activated unsaturated radical;
R₁, R₂ and R₇-R₉ are independently an alkyl, cycloalkyl or aryl, arylalkyl, or siloxanyl,
R₃-R₆ are independently alkyl, aryl, alkylaryl, or fluoroalkyl with the proviso that at least one of R₃-R₆ is a fluoroalkyl;
m and n are independently 0 to 200, m+n being from about 3 to 200; and a is 1 to 10.

2. A siloxane-containing, hydrogel comprising the monomer of claim 1.

3. The hydrogel of claim 2, wherein m+n of said polysiloxane prepolymer is about 3 to 200.

4. The hydrogel of claim 2, wherein said polysiloxane prepolymer is endcapped within the range of 1 to 70 mole % trimethylsilyl.

5. The hydrogel of claim 2, wherein said prepolymer is endcapped within the range of 25 to 50 mole % trimethylsilyl.

6. The hydrogel of claim 2, wherein said prepolymer is endcapped within the range of 40 to 50 mole % trimethylsilyl.

7. A contact lens comprising the hydrogel of claim 2.

8. An intraocular lens comprising the hydrogel of claim 2.
